(19) United States
(12) Patent Application Publication
(10) Pub. No.: US 2022/0179459 A1
(43) Pub. Date: Jun. 9, 2022

(54) Pivot Device with Multi-Stage Switching

(71) Applicant: Leohab Enterprise Co., Ltd., Taichung City (TW)

(72) Inventors: CHUN TI WANG, Taichung City (TW); FU CHUN CHUNG, Taichung City (TW); CHIH SHENG LIU, Taichung City (TW)

(21) Appl. No.: 17/114,583

(22) Filed: Dec. 8, 2020

(51) Int. Cl. G06F 1/16; F16C 11/04

(52) U.S. Cl. CPC G06F 1/1681; E05D 3/12; E05Y 2900/606; F16C 11/04

(57) ABSTRACT

A pivot device includes first and second shafts. A first torque component unit is coupled to an end of the first shaft. A second torque component unit is coupled to an end of the second shaft. A positioning unit is coupled to another ends of the first and second shafts and includes a first positioning board, a second positioning board, and a positioning block. A first transmission unit is disposed between the first and second positioning boards. A second transmission unit is disposed between the second positioning board and the positioning block. Each of the first and second transmission units includes a wheel mounted on the first shaft, a cam mounted on the second shaft, and a sliding block movable between the wheel and the cam, with each sliding block selectively stopping the wheel or the cam to prevent rotation of the first or second shaft, providing multi-stage switching.

### BACKGROUND OF THE INVENTION

The present invention relates to a pivot device and, more particularly, to a pivot device with multi-stage switching.

Pivot devices are widely used on foldable electronic devices, such as notebook computers or separable and transformable tablet computers, which can pivot through the pivot devices to allow users to adjust the electronic devices to a suitable status for use. Through pivoting operation provided by the pivotal devices, the displays can provide a maximized view and versatility.

Through wide application of the pivot devices while electronic devices seek user-friendly designs based on use experience, such as requirement of positioning points during opening and closing, 360° flipping, etc. It is an important issue to provide other functional demands in addition to the flipping function of the pivot devices.

### BRIEF SUMMARY OF THE INVENTION

The present invention provides a pivot device with multi-stage switching. The pivot device comprises a first shaft, a second shaft, a positioning unit, a first transmission unit, and a second transmission unit. The first shaft includes a first proximal end and a first distal end. A first fixing plate is coupled to the first proximal end and is configured to couple with a display unit of an electronic device. A first torque component unit is coupled to the first distal end. A second shaft includes a second proximal end and a second distal end. A second fixing plate is coupled to the second proximal end and is configured to couple with a system unit of the electronic device. A second torque component unit is coupled to the second distal end. The positioning unit is coupled to the first shaft and the second shaft and includes a first positioning board, a second positioning board, and a positioning block. The first positioning board, the second positioning board, and the positioning block are spaced from each other. The first positioning block is contiguous to the first proximal end and the second proximal end. The second positioning board is located between the first positioning board and the positioning block. The positioning block is contiguous to the first distal end and the second distal end and abuts against the first torque component unit and the second torque component unit. The first transmission unit is disposed between the first positioning board and the second positioning board and includes a first wheel mounted on the first shaft, a first cam mounted on the second shaft, and a first sliding block movable between the first wheel and the first cam. The first sliding block selectively stops the first wheel or the first cam in response to relative rotation between the first shaft and the second shaft. The second transmission unit is disposed between the second positioning board and the positioning block and includes a second wheel mounted on the first shaft, a second cam mounted on the second shaft, and a second sliding block movable between the second wheel and the second cam. The second sliding block selectively stops the first wheel or the second wheel in response to relative rotation between the first shaft and the second shaft.

In an example, the positioning block includes a first limiting portion adjacent to the first shaft. The second wheel includes a second limiting portion. The second limiting portion selectively abuts against the first limiting portion in response to rotation of the first shaft.

In an example, the first wheel includes a first recess. The first recess of the first wheel and the first sliding block selectively position each other to prevent rotation of the first shaft.

In an example, the second cam includes a stop portion. The stop portion of the second cam and the second sliding block selectively position each other. The first wheel pushes the first sliding block towards the first cam.

In an example, the first cam includes a stop portion. The stop portion of the first cam and the first sliding block selectively position each other to prevent rotation of the second shaft.

In an example, the stop portion of the first cam and the first sliding block selectively position each other to prevent rotation of the second shaft in a counterclockwise direction. The second cam pushes the second sliding block towards the second wheel. The first limiting portion and the second limiting portion position each other to prevent rotation of the first shaft in a clockwise direction.

In an example, the second wheel includes a recess. The recess of the second wheel and the second sliding block selectively position each other to prevent rotation of the first shaft.

In the pivot device with multi-stage switching of the embodiment according to the present invention, by providing the first sliding block movable between the first wheel and the first cam and the second sliding block movable between the second wheel and the second cam, when the first shaft and the second shaft are at in a predetermined angular relation with each other, rotation of the first shaft or the second shaft can be prevented, providing a multi-stage switching effect.

The present invention will become clearer in light of the following detailed description of illustrative embodiments of this invention described in connection with the drawings.

### DESCRIPTION OF THE DRAWINGS

FIG. 1 is a perspective view of a pivot device with multi-stage switching of an embodiment according to the present invention.

FIG. 2 is an exploded, perspective view of the pivot device of FIG. 1.

FIG. 3A is a cross sectional view of FIG. 1, with the pivot device in a 0° position.

FIG. 3B is another cross sectional view of FIG. 1.

FIG. 4A is a cross sectional view similar to FIG. 3A, with the pivot device in a 90° position.

FIG. 4B is a cross sectional view similar to FIG. 3B, with the pivot device in the 90° position.

FIG. 5A is a cross sectional view similar to FIG. 3A, with the pivot device in a 180° position.

FIG. 5B is a cross sectional view similar to FIG. 3B, with the pivot device in the 180° position.

FIG. 6A is a cross sectional view similar to FIG. 3A, with the pivot device in a 270° position.

FIG. 6B is a cross sectional view similar to FIG. 3B, with the pivot device in the 270° position.

FIG. 7A is a cross sectional view similar to FIG. 3A, with the pivot device in a 360° position.

FIG. 7B is a cross sectional view similar to FIG. 3B, with the pivot device in the 360° position.

### DETAILED DESCRIPTION OF THE INVENTION

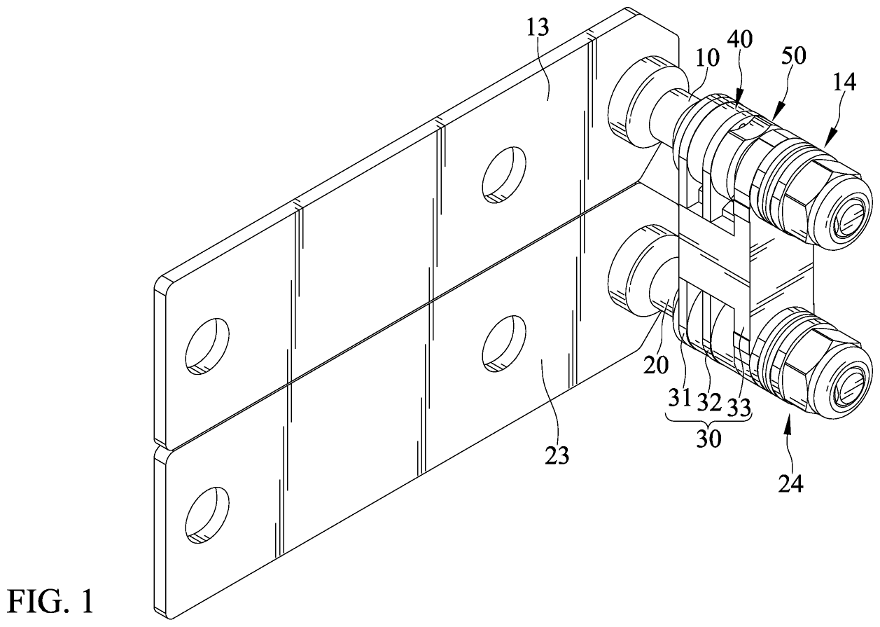

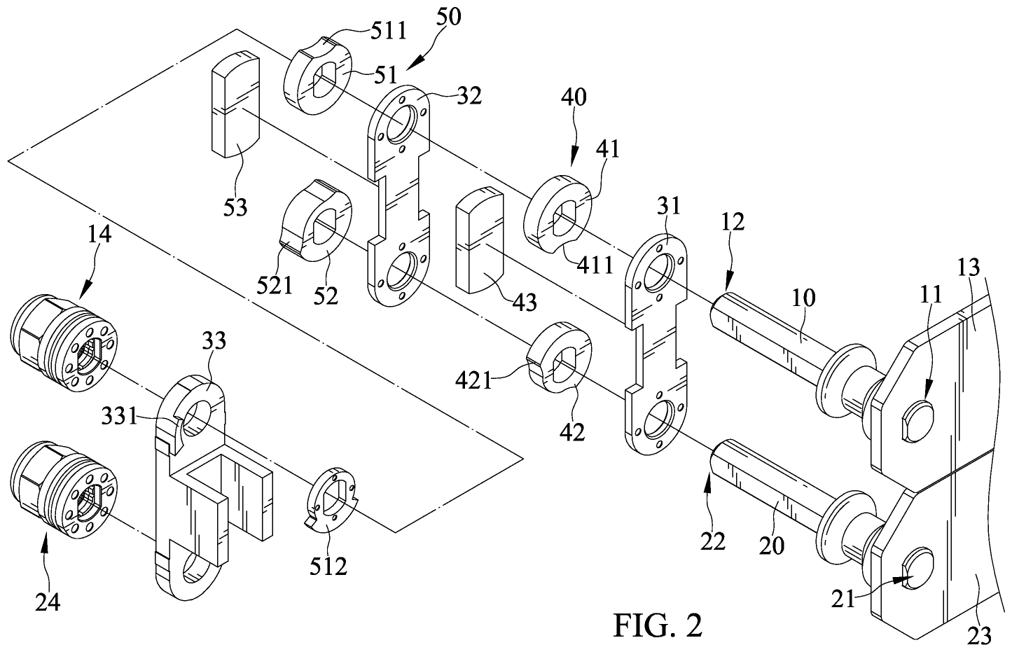

With reference to FIGS. 1 and 2, a pivot device with multi-stage switching of an embodiment according to the present invention comprises a first shaft 10, a second shaft 20, a positioning unit 30, a first transmission unit 40, and a second transmission unit 50.

The first shaft 10 includes a first proximal end 11 and a first distal end 12. A first fixing plate 13 is coupled to the first proximal end 11 and is configured to couple with a display unit (not shown) of an electronic device (not shown). A first torque component unit 14 is coupled to the first distal end 12. The second shaft 20 includes a second proximal end 21 and a second distal end 22. A second fixing plate 23 is coupled to the second proximal end 21 and is configured to couple with a system unit (not shown) of the electronic device. A second torque component unit 24 is coupled to the second distal end 22. The first torque component unit 14 and the second torque component unit 24 can be in the form of a conventional component for generating a torque, such as a spring, a spring leaf, etc., and detailed description thereof is not set forth to avoid redundancy.

The positioning unit 30 is coupled to the first shaft 10 and the second shaft 20 and includes a first positioning board 31, a second positioning board 32, and a positioning block 33. The first positioning board 31, the second positioning board 32, and the positioning block 33 are spaced from each other. The first positioning board 31 is contiguous to the first proximal end 11 and the second proximal end 21. The second positioning board 32 is located between the first positioning board 31 and the positioning block 33. The positioning block 33 is contiguous to the first distal end 12 and the second distal end 22 and abuts against the first torque component unit 14 and the second torque component unit 24.

The first transmission unit 40 is disposed between the first positioning board 31 and the second positioning board 32 and includes a first wheel 41 mounted on the first shaft 10, a first cam 42 mounted on the second shaft 20, and a first sliding block 43 movable between the first wheel 41 and the first cam 42. The first sliding block 43 selectively stops the first wheel 41 or the first cam 42 in response to relative rotation between the first shaft 10 and the second shaft 20, thereby preventing rotation of the first shaft 10 or the second shaft 20.

The second transmission unit 50 is disposed between the second positioning board 32 and the positioning block 33 and includes a second wheel 51 mounted on the first shaft 10, a second cam 52 mounted on the second shaft 20, and a second sliding block 53 movable between the second wheel 51 and the second cam 52. The second sliding block 53 selectively stops the second wheel 51 or the second cam 52 in response to relative rotation between the first shaft 10 and the second shaft 20, thereby preventing rotation of the first shaft 10 or the second shaft 20.

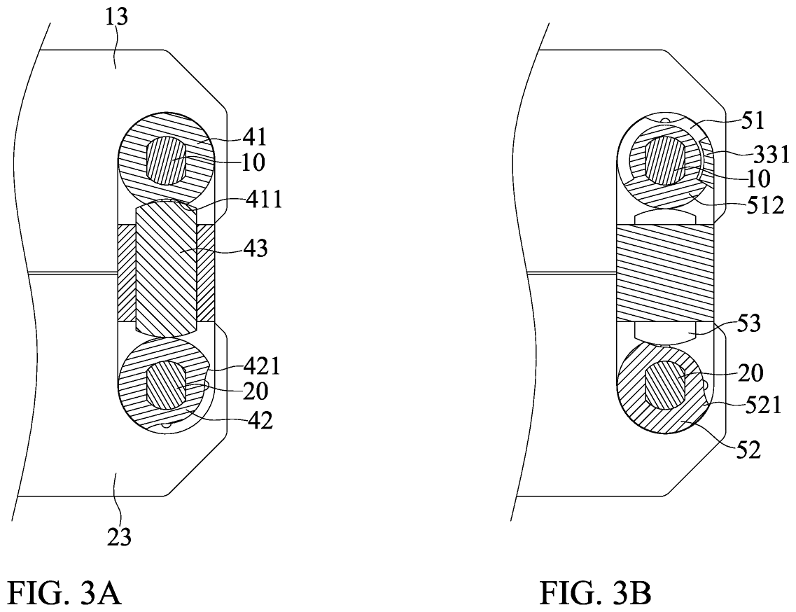

With reference to FIGS. 3A and 3B, the first wheel 41 includes a first recess 411. When the relative rotational angle between the first shaft 10 and the second shaft 20 is 0°, the first recess 411 of the first wheel 41 and an end of the first sliding block 43 position each other to prevent rotation of the first shaft 10, preventing rotation of the first shaft 10. Another end of the first sliding block 43 abuts against an outer periphery of the first cam 42. Two opposite ends of the second sliding block 53 abut against an outer periphery of the first wheel 41 and an outer periphery of the second wheel 51, respectively, such that only the second shaft 20 can rotate in the clockwise direction.

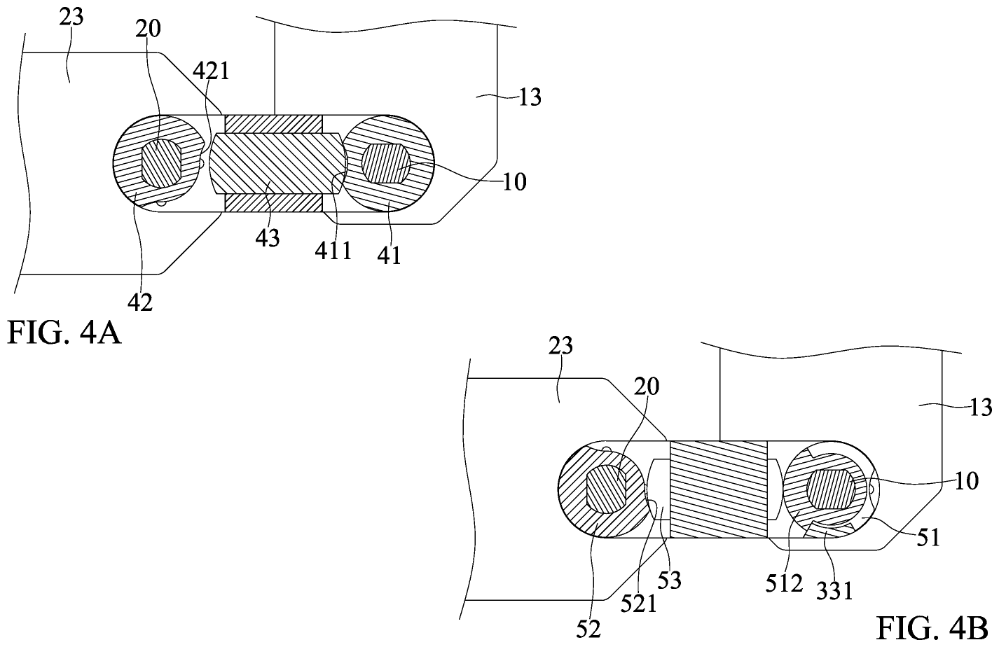

With reference to FIGS. 4A and 4B, the second cam 52 includes a stop portion 521. When the relative rotational angle between the first shaft 10 and the second shaft 20 is 90°, the stop portion 521 of the second cam 52 and the second sliding block 53 position each other, preventing rotation of the second shaft 20. Furthermore, the first wheel 41 pushes the first sliding block 43 towards the first cam 42.

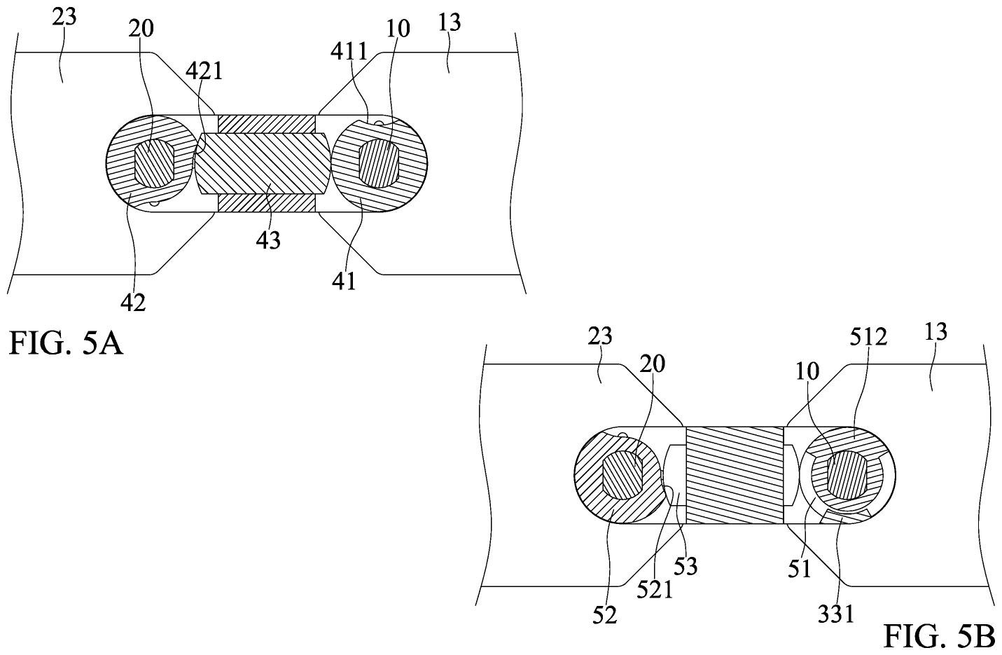

With reference to FIGS. 5A and 5B, the first cam 42 includes a stop portion 421. When the relative rotational angle between the first shaft 10 and the second shaft 20 is 180°, the stop portion 421 of the first cam 42 and the first sliding block 43 position each other to prevent rotation of the second shaft 20, and the stop portion 521 of the second cam 52 and the second sliding block 53 position each other, preventing rotation of the second shaft 20. Thus, only the first shaft 10 can rotate.

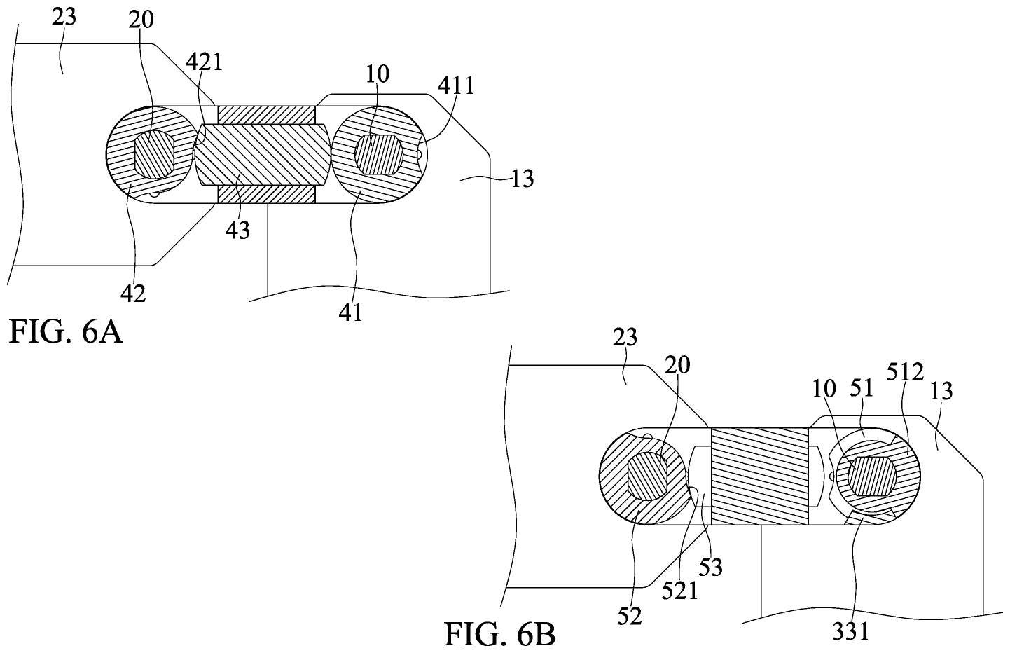

With reference to FIGS. 6A and 6B, the positioning block 33 includes a first limiting portion 331 adjacent to the first shaft 10. The second wheel 51 includes a second limiting portion 512. The second limiting portion 512 selectively abuts against the first limiting portion 331 in response to rotation of the first shaft 10. When the relative rotational angle between the first shaft 10 and the second shaft 20 is 270°, the stop portion 421 of the first cam 42 and the first sliding block 43 position each other to prevent rotation of the second shaft 20 in a counterclockwise direction, and the second cam 52 pushes the second sliding block 53 towards the second wheel 51. Furthermore, the first limiting portion 331 and the second limiting portion 512 position each other to prevent rotation of the first shaft 10 in a clockwise direction.

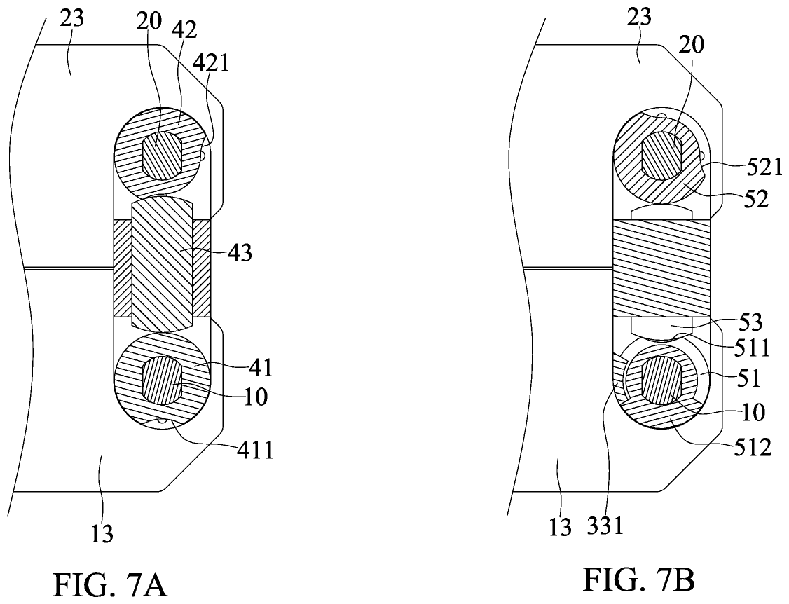

With reference to FIGS. 7A and 7B, the second wheel 51 includes a recess 511. When the relative rotational angle between the first shaft 10 and the second shaft 20 is 360°, the recess 511 of the second wheel 51 and the second sliding block 53 position each other to prevent rotation of the first shaft 10.

The above relative rotational angles are merely examples for illustration of the embodiment. The relative rotational angles can be varied according to user needs, such as 0°-100°, 100°-280°, 280°-360°, etc. According to the above description, by positioning the first sliding block 43 and the second sliding block 53, the first shaft 10 can rotate between 90°-270°, and the second shaft 20 can rotate between 270°-360°.

In view of the foregoing, in the pivot device with multi-stage switching of the embodiment according to the present invention, by providing the first sliding block 43 movable between the first wheel 41 and the first cam 42 and the second sliding block 53 movable between the second wheel 51 and the second cam 52, when the first shaft 10 and the second shaft 20 are at in a predetermined angular relation with each other, rotation of the first shaft 10 or the second shaft 20 can be prevented, providing a multi-stage switching effect.

Although specific embodiments have been illustrated and described, numerous modifications and variations are still possible without departing from the scope of the invention. The scope of the invention is limited by the accompanying claims. It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

1. A pivot device with multi-stage switching, comprising:
a first shaft including a first proximal end and a first distal end, wherein a first fixing plate is coupled to the first proximal end and is configured to couple with a display unit of an electronic device, and wherein a first torque component unit is coupled to the first distal end;
a second shaft including a second proximal end and a second distal end, wherein a second fixing plate is coupled to the second proximal end and is configured to couple with a system unit of the electronic device, and wherein a second torque component unit is coupled to the second distal end;
a positioning unit coupled to the first shaft and the second shaft and including a first positioning board, a second positioning board, and a positioning block, wherein the first positioning board, the second positioning board, and the positioning block are spaced from each other, wherein the first positioning board is contiguous to the first proximal end and the second proximal end, wherein the second positioning board is located between the first positioning board and the positioning block, wherein the positioning block is contiguous to the first distal end and the second distal end and abuts against the first torque component unit and the second torque component unit;
a first transmission unit disposed between the first positioning board and the second positioning board and including a first wheel mounted on the first shaft, a first cam mounted on the second shaft, and a first sliding block movable between the first wheel and the first cam, wherein the first sliding block selectively stops the first wheel or the first cam in response to relative rotation between the first shaft and the second shaft; and
a second transmission unit disposed between the second positioning board and the positioning block and including a second wheel mounted on the first shaft, a second cam mounted on the second shaft, and a second sliding block movable between the second wheel and the second cam, wherein the second sliding block selectively stops the first wheel or the second wheel in response to relative rotation between the first shaft and the second shaft.

2. The pivot device with multi-stage switching as claimed in claim 1, wherein the positioning block includes a first limiting portion adjacent to the first shaft, wherein the second wheel includes a second limiting portion, and wherein the second limiting portion selectively abuts against the first limiting portion in response to rotation of the first shaft.

3. The pivot device with multi-stage switching as claimed in claim 2, wherein the first wheel includes a first recess, and wherein the first recess of the first wheel and the first sliding block selectively position each other to prevent rotation of the first shaft.

4. The pivot device with multi-stage switching as claimed in claim 3, wherein the second cam includes a stop portion, wherein the stop portion of the second cam and the second sliding block selectively position each other, and wherein the first wheel pushes the first sliding block towards the first cam.

5. The pivot device with multi-stage switching as claimed in claim 4, wherein the first cam includes a stop portion, and wherein the stop portion of the first cam and the first sliding block selectively position each other to prevent rotation of the second shaft.

6. The pivot device with multi-stage switching as claimed in claim 5, wherein the stop portion of the first cam and the first sliding block selectively position each other to prevent rotation of the second shaft in a counterclockwise direction, wherein the second cam pushes the second sliding block towards the second wheel, and wherein the first limiting portion and the second limiting portion position each other to prevent rotation of the first shaft in a clockwise direction.

7. The pivot device with multi-stage switching as claimed in claim 6, wherein the second wheel includes a recess, wherein the recess of the second wheel and the second sliding block selectively position each other to prevent rotation of the first shaft.
